(19) United States
(12) Patent Application Publication
(10) Pub. No.: US 2020/0249723 A1
(43) Pub. Date: Aug. 6, 2020

(54) FOLDABLE PORTABLE INFORMATION DEVICE

(71) Applicant: LENOVO (SINGAPORE) PTE. LTD., SINGAPORE (SG)

(72) Inventors: Fumitake Mizoguchi, Kanagawa (JP); Takehito Yamauchi, Kanagawa (JP); Ryo Oshige, Kanagawa (JP); Eiji Shinohara, Kanagawa (JP); Kazuya Tatsuno, Kanagawa (JP)

(21) Appl. No.: 16/747,304

(22) Filed: Jan. 20, 2020

(30) Foreign Application Priority Data
Feb. 1, 2019 (JP) 2019-16767

(51) Int. Cl. G06F 1/16

(52) U.S. Cl. CPC G06F 1/1652; G06F 1/1626; G06F 1/1681

(57) ABSTRACT

A portable information device is disclosed. The portable information device includes a pair of chassis members, a hinge mechanism that rotatably connects respective one edge portions of the pair of chassis members, a foldable display provided straddling the inner surfaces of the pair of chassis members, and a bezel member provided straddling the outer circumferential edge portion of the display and the outer circumferential edge portion of the chassis members such that the bezel member is disposed farther from the rotation center of the hinge mechanism relative to the inner surfaces of the chassis members. The bezel member includes a core member secured on the outer circumferential edge portion of the display and the outer circumferential edge portion of the chassis members, and a surface member made of elastic member and provided on the front surface of the core member.

### PRIORITY CLAIM

The present application claims benefit of priority under 35 U.S.C. §§ 120, 365 to the previously filed Japanese Patent Application No. JP2019-16767 with a priority date of Feb. 1, 2019, which is incorporated by reference herein.

### TECHNICAL FIELD

The present invention relates to portable information devices in general, and in particular to a foldable portable information device.

### BACKGROUND

In recent years, portable information devices, such as tablet personal computers (PC) or smart phones, that have a touch panel-type display but not a physical keyboard have been becoming more popular. The display of this type of portable information device is desirably large when the device is being used, and is desirably made smaller when the device is not being used.

In a conventional portable information configuration, a bezel member is mounted on the outer circumferential edge portion of the front surface of the display to support the outer circumferential edge portion of the display and to also improve the quality of its external appearance. The bezel member is divided into a pair of bezel portions at a position where the bezel member overlaps a hinge mechanism to avoid interference with the opening and closing motion of chassis members. In other words, as the bezel member is divided on the way of the entire circumference of the outer circumferential edge portion of the display, the divided portion appears on the external appearance, which makes poorer external appearance.

Further, in the above-mentioned structure, the rotation center at the time of folding the chassis members via the hinge mechanism matches with the front surface of the display, so that smooth folding motion of the display is achieved. For this purpose, the bezel member is positioned more inward than the rotation center of the hinge mechanism when folding the chassis members. Thus, when the bezel member is made of hard resin material, for example, a compressing force generated in folding causes the divided end faces of the bezel member to forcibly abut on the front surface of the display, which can cause deficiency of the display.

Consequently, it would be desirable to provide an improved portable information device capable of preventing a bezel member from interfering with a display.

### SUMMARY

In accordance with an embodiment of the present disclosure, a foldable portable information device includes a pair of chassis members disposed such that respective one edge portions thereof are disposed adjacent to each other; a hinge mechanism that rotatably connects the respective one edge portions of the pair of chassis members; a foldable display provided straddling the inner surfaces of the pair of chassis members; and a bezel member provided straddling the outer circumferential edge portion of the display and the outer circumferential edge portion of the chassis members such that the bezel member is disposed farther from the rotation center of the hinge mechanism relative to the inner surfaces of the chassis members, wherein the bezel member includes a core member secured relative to the outer circumferential edge portion of the display and the outer circumferential edge portion of the chassis members, and a surface member made of elastic material and provided on the front surface of the core member, the surface member is provided extending over the entire length of the outer circumferential edge portion of the display, and the core member is provided on the outer circumferential edge portion of the display except a portion of the outer circumferential edge portion, the portion including the respective one edge portions of the pair of chassis members.

With the above-mentioned structure, the bezel member includes a core member and an elastic surface member. Thus, even though the bezel member covers the entire length of the outer circumferential edge portion of the display, the elastic surface member does not hinder the folding motion of the pair of chassis members. This can improve the external appearance of the portable information device. In addition, as the core member of the bezel member is disposed outside the folding region of the chassis members, the core member can be prevented from interfering with the display in the opening and closing motion of the chassis members. Further, as the surface member has elasticity, even if a portion corresponding to the folding region between the chassis members receives a compressing force, the compressing force can be smoothly absorbed, which can prevent wrinkles or sags of the bezel member. Moreover, as to the bezel member, the core member harder than the surface member is secured relative to the display and the chassis members. Hence, should a step be formed between the front surface of the display and the upper surface of the chassis member, since the hard core member is disposed straddling the step, the bezel member can be saved from formation of a step or sag, for example, on the soft surface member on the outside surface due to the influence of the step. This can further improve the quality of the external appearance.

All features and advantages of the present disclosure will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a perspective view of a portable information device according to one embodiment, the portable information device being in a close position;

FIG. 2 is a perspective view of the portable information device from FIG. 1, the portable information device being in an open position;

FIG. 3 is a plan view of the inside structure of the portable information device from FIG. 2;

FIG. 4 is a cross-sectional view illustrating a cross-sectional structure of the portable information device from FIG. 2;

FIG. 5 is a plan view of the portable information device from FIG. 2;

FIG. 6 is a cross-sectional view along the line VI-VI in FIG. 5;

FIG. 7 is a cross-sectional view along the line VII-VII in FIG. 5;

FIG. 8 is a cross-sectional view of a bezel member according to a modified example;

FIG. 9 is a cross-sectional view of a structure in which a surface member includes a bridge portion instead of a protrusion;

FIG. 10 is an enlarged perspective view of major portions, illustrating the positional relationship between a display, the bezel member, and a hinge mechanism;

FIG. 11A is a side view illustrating the positional relationship between the display, the bezel member, and the hinge mechanism with the chassis members open;

FIG. 11B is a side view illustrating the chassis members being closed from the state illustrated in FIG. 11A;

FIG. 11C is a side view illustrating the chassis members being further closed and folded from the state illustrated in FIG. 11B;

FIG. 12 is a diagram illustrating a method for manufacturing a portable information device;

FIG. 13A is a diagram illustrating another method for manufacturing a portable information device; and

FIG. 13B is a diagram illustrating the bezel member secured on the display and a first chassis member from the state illustrated in FIG. 13A.

### DETAILED DESCRIPTION

### I. Structure of Portable Information Device

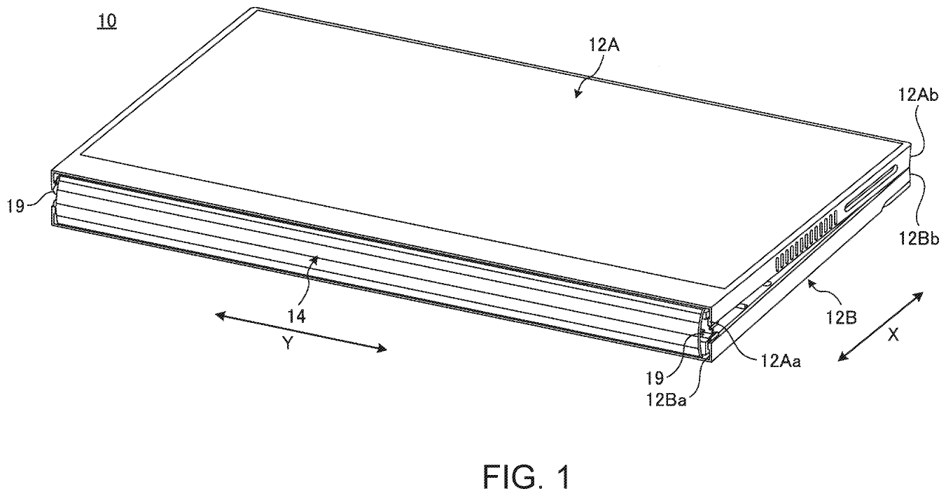

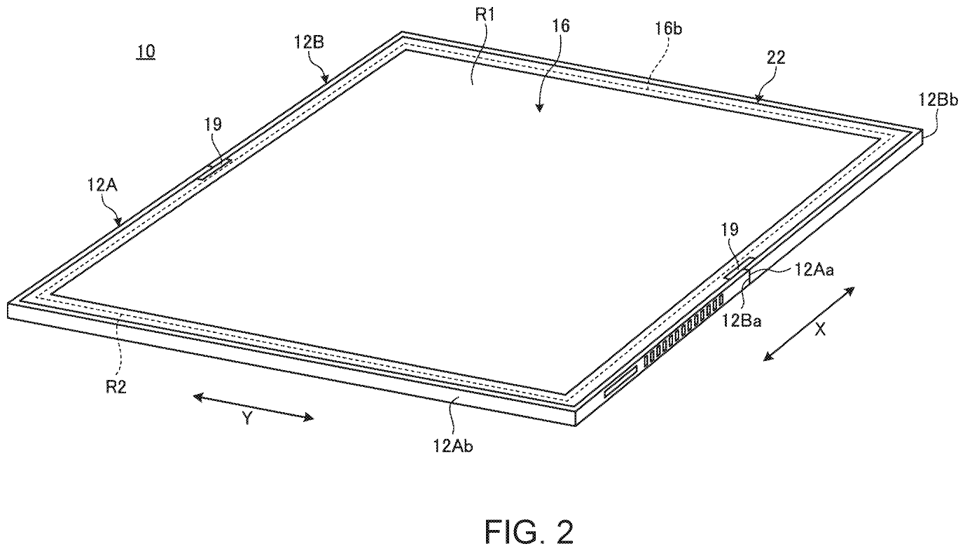

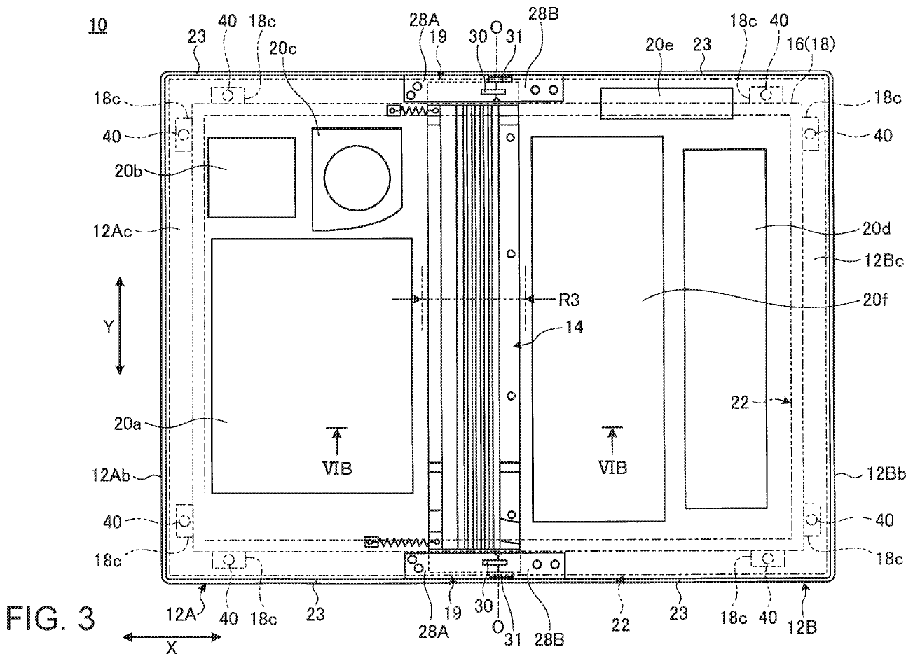

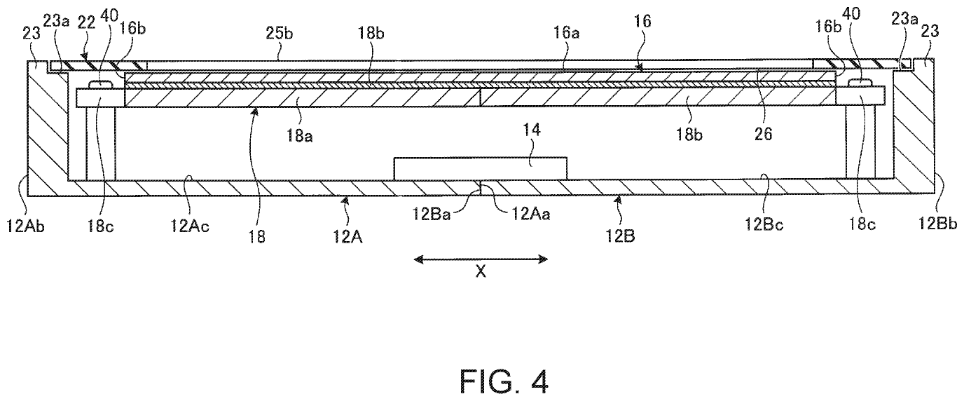

FIG. 1 is a perspective view of a portable information device 10 according to an embodiment, which is closed to be in a stored state. FIG. 2 is a schematic perspective view of the portable information device 10 illustrated in FIG. 1, which is open to be in a use state. FIG. 3 is a schematic plan view of the inside structure of the portable information device 10 illustrated in FIG. 2. FIG. 4 is a schematic cross sectional view of the cross sectional structure of the portable information device 10 illustrated in FIG. 2.

As illustrated in FIG. 1 and FIG. 2, the portable information device 10 includes a first chassis member 12A, a second chassis member 12B, a spine member 14, and a display 16. In this embodiment, a foldable tablet PC that can be folded in half like a book will be described as an example of the portable information device 10. The portable information device 10 may be, for example, a portable phone, a smart phone, or an electronic organizer.

Each of the chassis members 12A, 12B is a rectangular plate member having lateral walls standing along its three edges other than an edge corresponding to the spine member 14. Each of the chassis members 12A, 12B is made of a plate of metal, such as stainless, magnesium, or aluminum, or of fiber-reinforced resin plate containing reinforced fibers, such as carbon fibers. On the side of the inner surfaces of the chassis members 12A, 12B, the display 16 is secured via a support plate 18 (refer to FIG. 4 as well). The chassis members 12A, 12B are connected to each other via a pair of hinge mechanisms 19, 19. The hinge mechanisms 19 connect the chassis members 12A, 12B in such a manner that allows the chassis members 12A, 12B to be folded or unfolded to be in a stored state, as illustrated in FIG. 1, or in a use state, as illustrated in FIG. 2. The line O indicated by a one-dot chain line in FIG. 3 indicates a folding center O, which makes the center of a folding motion of the chassis members 12A, 12B.

The inside end faces 12Aa, 12Ba on the side of the spine member 14 of the respective chassis members 12A, 12B correspond to the side of the hinge, while the outside end faces 12Ab, 12Bb on the side opposite from the spine member 14 correspond to the side of the open end.

In the following, the portable information device 10 will be described, based on an assumption that, as illustrated in FIG. 1 to FIG. 3, the direction from the spine member 14 toward the respective outside end faces 12Ab, 12Bb is referred to as the X direction, and the direction along the longitudinal direction of the spine member 14 is referred to as the Y direction.

As illustrated in FIG. 3, on the inside surface 12Ac of the first chassis member 12A, a main substrate 20a, a communication module 20b, and a cooling fan 20c, for example, are securely mounted with screws, not illustrated. On the inside surface 12Bc of the second chassis member 12B, a sub-substrate 20d, an antenna 20e, and a battery 20f, for example, are securely mounted with screws, not illustrated.

The display 16 is, for example, a liquid crystal display of a touch plane type. The display 16 has a structure that allows the display 16 to be folded together with the chassis members 12A, 12B when the chassis members 12A, 12B are being folded. The display 16 is, for example, an organic electroluminescent (EL) flexible display having a highly flexible paper structure, for example, to be opened or closed along with the opening or closing motion of the chassis members 12A, 12B.

The display 16 is securely mounted on the side of the inside surfaces 12Ac, 12Bc of the respective chassis members 12A, 12B via the support plate 18 with screws, not illustrated. As illustrated in FIG. 4, the rear surface of the display surface (the front surface 16a) of the display 16 is adhesively secured on the front surface of the support plate 18, for example, with an adhesive agent or a double stick tape. In this embodiment, the support plate 18 includes a pair of plate members 18a, 18b that are mutually connected so as to be foldable with the folding center O as the center. The pair of plate members 18a, 18a has a flexible sheet 18b made of metal foil, for example, and secured over the entire front surface of the plate members 18a, 18a, whereby the plate members 18a, 18a are connected to each other so as to be foldable.

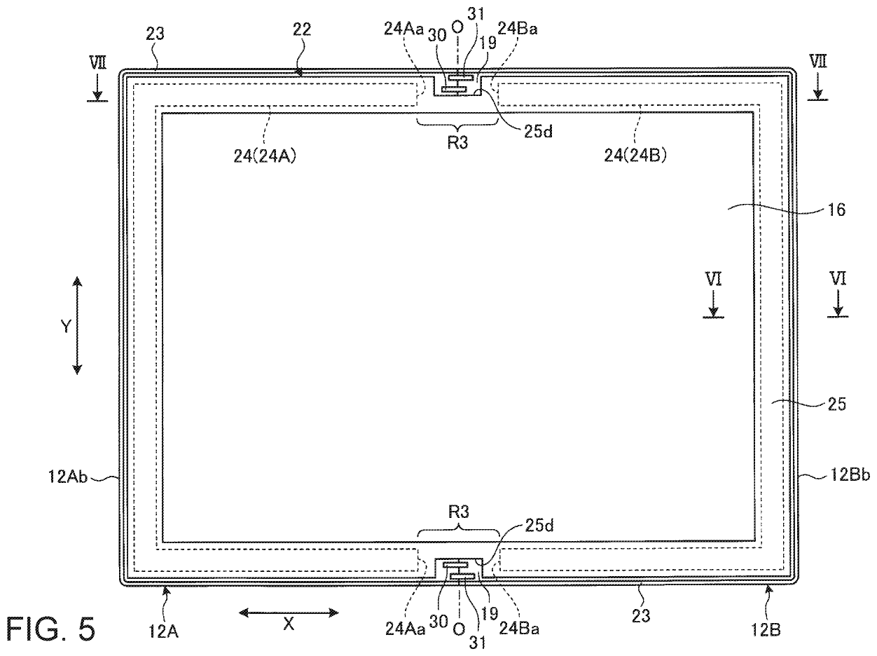

As illustrated in FIG. 2, a bezel member 22 is disposed on the outer circumferential edge portion 16b of the front surface 16a of the display 16 in the state of being secured on the side of the inner surfaces of the chassis members 12A, 12B (refer to FIG. 5 as well). Specifically, the bezel member 22 is provided covering a non-display region (a non-active region) R2 provided on the outer circumferential edge portion 16b, or a region on the front surface of the display 16 excluding a display region (an active region) R1.

### II. Description of Bezel Member

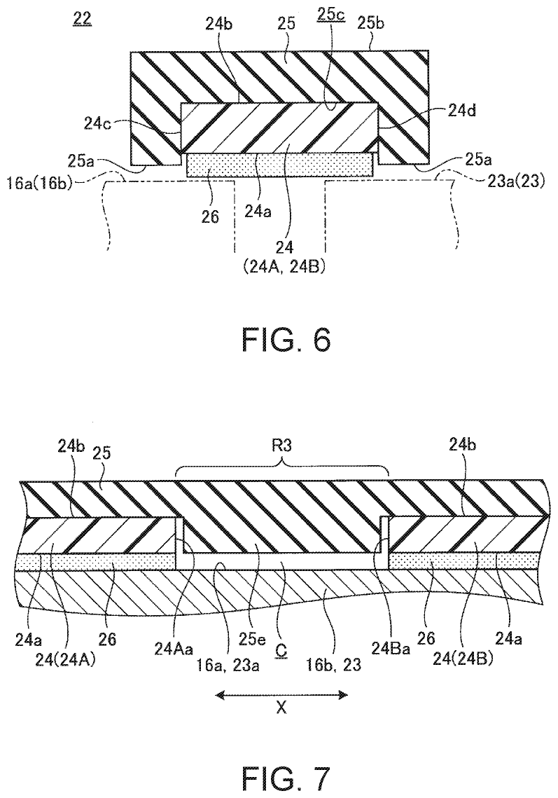

A specific exemplary structure of the bezel member 22 will be described. FIG. 5 is a plan view of the portable information device 10 illustrated in FIG. 2. FIG. 6 is a schematic cross sectional view along the line VI-VI in FIG. 5. FIG. 7 is a schematic cross sectional view along the line VII-VII in FIG. 5.

As illustrated in FIG. 4, the bezel member 22 is provided straddling the front surface 16a of the outer circumferential edge portion 16b of the display 16 and the outer circumferential edge portion 23 of the chassis members 12A, 12B open flat, or to be like a single plate. With the above, the bezel member 22 supports the outer circumferential edge portion 16b of the display 16 and also covers a space or a step resulted between the outer circumferential edge portion 16b of the display 16 and the outer circumferential edge portion 23 of the chassis members 12A, 12B. As illustrated in FIG. 5, the bezel member 22 is provided over the entire length of the outer circumferential edge portion 16b of the display 16, and is shaped like a rectangular frame in a plan view. That is, the bezel member 22 extends along three edges except an edge along the inside end face 12Aa of the first chassis member 12A and three edges except an edge along the inside end face 12Ba of the second chassis member 12B.

As illustrated in FIG. 5 to FIG. 7, the bezel member 22 has a two-layer structure including a core member 24 and a surface member 25.

The core member 24 is made of hard resin material, for example, polycarbonate, so as to have a rectangular cross section. The lower surface 24a of the core member 24 makes a surface to be secured relative to the display 16 and the chassis members 12A, 12B, and the upper surface 24b and the lateral surfaces 24c, 24d on the respective both sides are covered with the surface member 25. The lower surface 24a is secured relative to the front surface 16a of the outer circumferential edge portion 16b of the display 16 and the upper surface 23a of the outer circumferential edge portion 23 of the chassis members 12A, 12B with a double stick tape 26. An adhesive agent, for example, may be used instead of the double stick tape 26.

The core member 24 is provided on a portion other than a portion (a folding region R3) containing the hinge mechanisms 19 for connection between the chassis members 12A, 12B (refer to FIG. 5). The core member 24 includes a first portion 24A to be secured on the first chassis member 12A and a second portion 24B to be secured on the second chassis member 12B (refer to FIG. 5). That is, the core member 24 is divided into the first portion 24A and the second portion 24B by the folding regions R3. The respective portions 24A, 24B are each formed to have a substantial U-shape in a plan view, and are symmetrical to each other. The end face 24Aa of the first portion 24A and the end face 24Ba of the second portion 24B are disposed opposed to each other with the folding region R3 in-between. This can prevent the hard core member 24 from interfering with the opening and closing motion of the chassis members 12A, 12B. Further, as the core member 24 is secured on the surface member 25 and deforms together with the surface member 25, the end faces 24Aa, 24Ba of the core member 24 can be prevented from sticking out to interfere with the front surface 16a of the display 16 when the chassis members 12A, 12B are folded in half

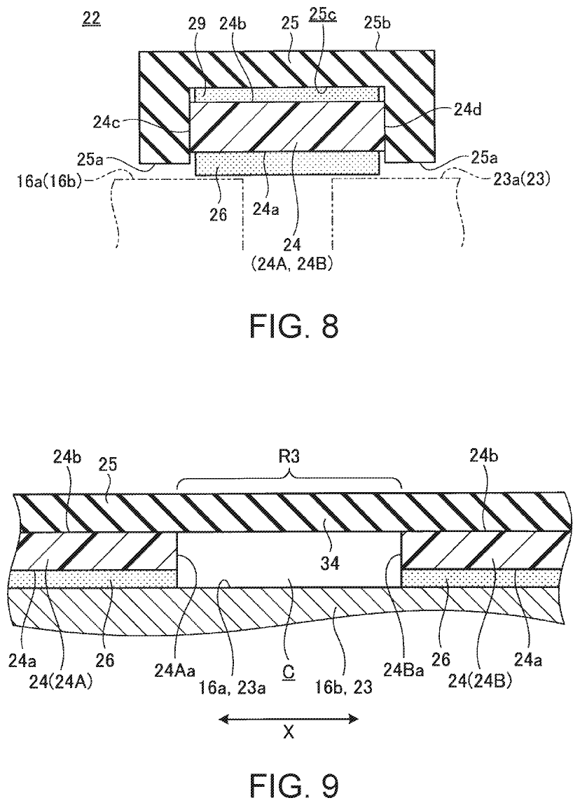

The surface member 25 is made of soft elastic material, for example, silicone rubber, so as to have a substantially gate-shaped cross section. The surface member 25 is formed integral to the core member 24 through insert molding, for example. The surface member 25 has a recessed portion 25c formed by partially recessing the lower surface 25a of the surface member 25 toward the upper surface 25b. The core member 24 is held inside the recessed portion 25c. With the above, as the entire outside surface of the bezel member 22 is covered with the surface member 25, the quality of the external appearance is improved. Although FIG. 6 illustrates a structure as an example in which the core member 24 is fully held in the recessed portion 25c, the core member 24 may be, for example, partially held inside the recessed portion 25c such that the lower surface 24a projects below the recessed portion 25c. Alternatively, as illustrated in FIG. 8, the surface member 25 may not be formed through insert molding, but may be attached on the upper surface 24b of the core member 24 with a double stick tape 29 or an adhesive agent.

The surface member 25 is provided over the entire length (the entire circumference) of the outer circumferential edge portion 16b of the display 16. That is, the surface member 25 is a frame member that surrounds the display 16 in a plan view. In this embodiment, the surface member 25 has a cutout 25d at a position corresponding to the folding region R3 to avoid the hinge mechanism 19, which projects upward (refer to FIG. 5). Note that the cutout 25d is omissible, for example, depending on the specification of the hinge mechanism 19.

Further, the surface member 25 has a protrusion 25e protruding downward formed on a portion corresponding to the folding region R3 (refer to FIG. 7). The protrusion 25e is inserted in the space C between the end face 24Aa of the first portion 24A of the core member 24 and the end face 24Ba of the second portion 24B. Although FIG. 7 illustrates a structure as an example in which the lower surface of the protrusion 25e is positioned spaced apart from the front surface 16a of the display 16 and the upper surface 23a of the chassis members 12A, 12B, the lower surface of the protrusion 25e may be in contact with the front surface 16a or the upper surface 23a. Provision of the protrusion 25e can prevent sagging, for example, of the surface member 25 caused on a portion overlapping the space C. Alternatively, as illustrated in FIG. 9, the surface member 25 may have a bridge portion 34 straddling the space C, without the protrusion 25e.

### III. Relationship Between Bezel Member and Opening and Closing Motion of Chassis Members

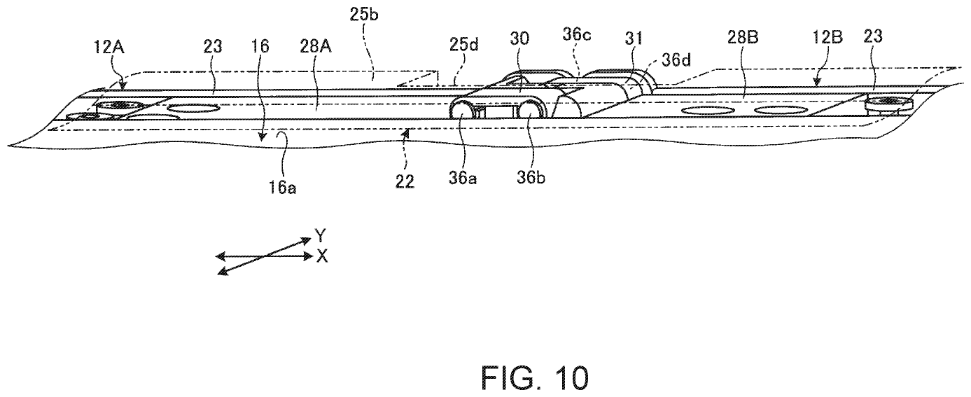

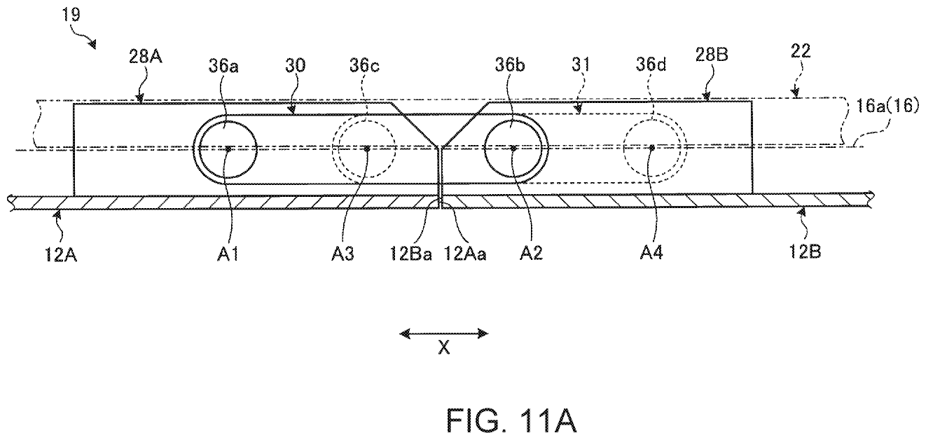

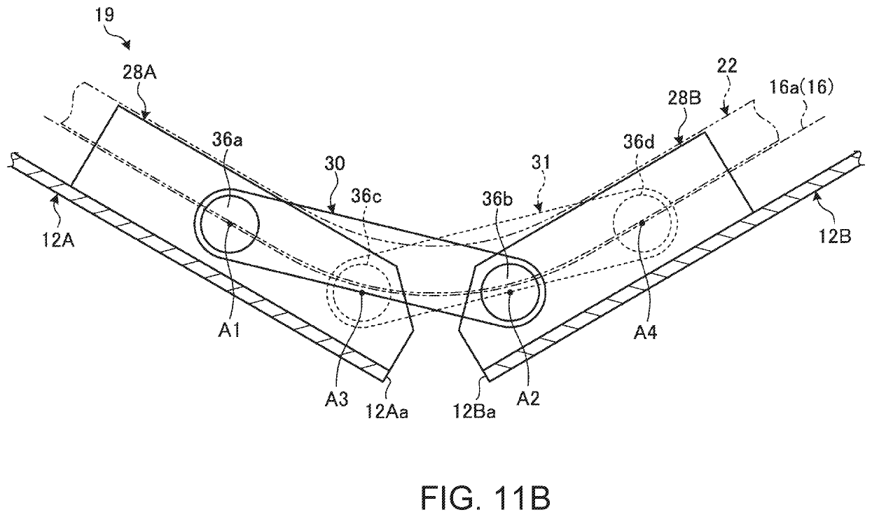

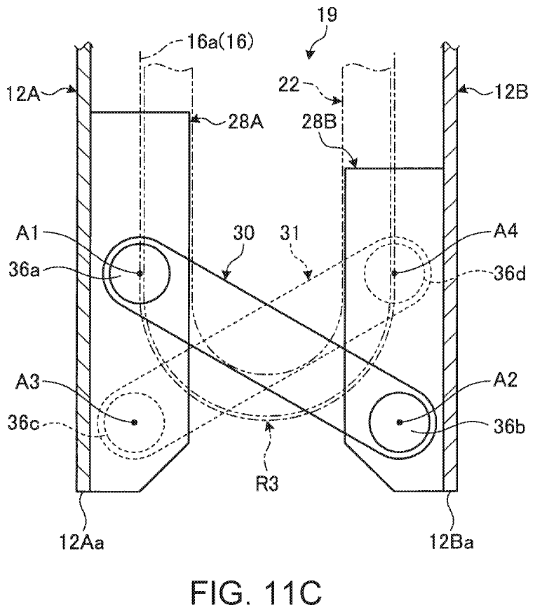

The relationship between the bezel member 22 and the opening and closing motion of the chassis members 12A, 12B will now be described. FIG. 10 is an enlarged perspective view of major portions, illustrating the positional relationship between the display 16, the bezel member 22, and the hinge mechanism 19. FIG. 11A is a side view schematically illustrating the positional relationship between the display 16, the bezel member 22, and the hinge mechanism 19, with the chassis members 12A, 12B open. FIG. 11B is a side view illustrating the chassis members 12A, 12B being closed from the state illustrated in FIG. 11A. FIG. 11C is a side view illustrating the chassis members 12A, 12B being further closed and folded from the state illustrated in FIG. 11B.

### A. Description of Hinge Mechanism

Initially, an exemplary structure of the hinge mechanism 19 will be described. As illustrated in FIG. 3 and FIG. 10, the hinge mechanisms 19 are disposed at respective positions overlapping the respective end portions of the spine member 14 in the longitudinal direction. The hinge mechanisms 19 are each disposed outside the outer circumferential edge portion 16b of the display 16 such that the hinge mechanisms 19 are symmetrical to each other. The hinge mechanism 19 includes a first hinge chassis 28A, a second hinge chassis 28B, a first arm 30, and a second arm 31.

Each of the hinge chassis 28A, 28B is a thin block component made of resin or metal, for example. The first hinge chassis 28A is securely screwed on the first chassis member 12A and the second hinge chassis 28B is securely screwed on the second chassis member 12B.

One end portion of the first arm 30 is rotatably connected to the first hinge chassis 28A via a first hinge shaft 36a, and the other end portion is rotatably connected to the second hinge chassis 28B via a second hinge shaft 36b (refers to FIG. 11A to FIG. 11C as well). One end portion of the second arm 31 is rotatably connected to the second hinge chassis 28B via a third hinge shaft 36d, and the other end portion is rotatably connected to the first hinge chassis 28A via a fourth hinge shaft 36c. The first arm 30 and the second arm 31 are aligned parallel to each other in the Y direction. The second hinge shaft 36b of the first arm 30 is positioned between the third hinge shaft 36c and the fourth hinge shaft 36d of the second arm 31. The third hinge shaft 36c of the second arm 31 is positioned between the first hinge shaft 36a and the second hinge shaft 36b of the first arm 30. With the above, the first arm 30 and the second arm 31 are alternately aligned with displacement in the X direction and the Y direction.

In the respective hinge mechanisms 19, when the chassis members 12A, 12B are folded with the folding center O as the center, the respective arms 30, 31 rotate via the respective hinge shafts 36a to 36d (refer to FIG. 11A to FIG. 11C). With the above, the hinge mechanism 19 connects the chassis members 12A, 12B in such a manner that allows the chassis members 12A, 12B to rotate from a state in which the chassis members 12A, 12B are folded to a state in which the chassis members 12A, 12B are open flat.

### B. Description of Positional Relationship Between Display, Bezel Member, and Hinge Mechanism

The positional relationship between the display 16, the bezel member 22, and the hinge mechanism 19 will now be described.

As illustrated in FIG. 4, the display 16 is mounted on the chassis members 12A, 12B via the support plate 18. As illustrated in FIG. 3, the hinge mechanisms 19 are disposed on the respective both end portions of the respective one edge portions (the inside end faces 12Aa, 12Ba) of the chassis members 12A, 12B in the longitudinal direction (the Y direction) so as to be outside the outer circumferential edge portion 16b of the display 16.

A mounting structure of the display 16 can be any structure without limitation, and as an example, the display 16 is positioned and secured on the chassis members 12A, 12B via mount pieces 18c of the support plate 18, as illustrated in FIG. 3. The mount piece 18c is a projecting piece provided at an arbitral position on the outer circumferential edge portion of the support plate 18 so as to project outward from the outer circumferential edge portion of each plate member 18a. The mount piece 18c has a through hole for screwing at the middle thereof. Fastening a securing screw 40 onto each of the chassis members 12A, 12B through the through hole can securely fasten the support plate 18 (the display 16) on the chassis members 12A, 12B. Alternatively, for example, a female screw like a boss may be provided on the lower surface of the plate member 18a, instead of the mount piece 18c.

The display 16 in this embodiment is foldable in half. Accordingly, the folding region R3, or a portion corresponding to the spine member 14 (refer to FIG. 3), of the display 16 is not secured on the chassis members 12A, 12B, and other portions are positioned and secured. Hence, the display 16 is to be folded in half while being positioned and secured on the chassis members 12A, 12B. This may possibly increase a load to be applied to the folding region R3 of the display 16 in an opening or closing motion to such an extent that hinders smooth folding of the display 16, depending on the positional relationship between the display 16 and the respective hinge shafts 36a to 36d of the hinge mechanism 19.

To address the above, the portable information device 10 has a structure, as illustrated in FIG. 10 and FIG. 11A, in which the front surface 16a of the display 16 and the shaft centers A1 to A4 of the hinge shafts 36a to 36d are disposed on the same plane when the chassis members 12A, 12B are open flat (in a use state). That is, the shaft centers A1 to A4 are disposed on a virtual plane matching with the front surface 16a of the display 16 open flat.

With this structure, while the chassis members 12A, 12B in a use state, as illustrated in FIG. 11A, are being folded, the respective arms 30, 31 rotate around the respective hinge shafts 36a to 36d, as illustrated in FIG. 11B, whereby the chassis members 12A, 12B are gradually folded, and so is the display 16. Finally, as illustrated in FIG. 11C, the chassis members 12A, 12B are folded in half, and the display 16 as well is folded in half so as to define an arc designed to have a predetermined curvature.

### IV. Description of Operation and Effect of Portable Information Device

As described above, the bezel member 22 is provided on the front surface 16a of the display 16. That is, the bezel member 22 is disposed farther (upper) than the rotation centers (shaft centers A1 to A4) of the hinge mechanism 19 relative to the inside surfaces 12Ac, 12Bc of the chassis members 12A, 12B. In other words, with the chassis members 12A, 12B closed, the bezel member 22 is positioned inside the shaft centers A1 to A4 (the front surface 16a of the display 16) of the hinge mechanism 19. This raises a concern that a portion of the bezel member 22 corresponding to the folding region R3 and a portion therearound receive a compressing force and thereby wrinkle or sag when the chassis members 12A, 12B are closed.

To address the above, in the portable information device 10 in this embodiment, the elastic surface member 25 is used for the bezel member 22 to therewith cover the entire length of the outer circumferential edge portion 16b of the display 16. That is, the surface member 25 of the bezel member 22 covers the entire length of the outer circumferential edge portion 16b of the display 16 without disconnection, which can improve the quality of the external appearance of the portable information device 10. In addition, as the bezel member 22 has elasticity, the bezel member 22 can be prevented from interfering with the opening and closing motion of the chassis members 12A, 12B. Moreover, as the surface member 25 has elasticity, the surface member 25 can smoothly absorb a compressing force even in a case where a portion of the surface member 25 corresponding to the folding region R3 receives a compressing force, which can prevent the bezel member 22 from wrinkling or sagging.

Moreover, the core member 24 of the bezel member 22, the core member 24 being harder than the surface member 25, is secured relative to the display 16 and the chassis members 12A, 12B. That is, although a step can be formed in some cases in the portable information device 10, such as is described above, between the front surface 16a of the display 16 and the upper surface 23a of the chassis members 12A, 12B due to some factors, such as an error in manufacturing or assembling, even in such a case, since the hard core member 24 is disposed straddling the step, the bezel member 22 in this embodiment can prevent, for example, wrinkles or sags of the soft surface member 25 on the outer surface due to the influence of the step. This can further improve the quality of the external appearance.

Nevertheless, a concern remains that, even though the bezel member 22 has the elastic surface member 25, in the case where a significantly large compression force is applied to the folding region R3, wrinkles or sagging can be caused. To address the above, the bezel member 22 in this embodiment has a structure in which the surface member 25 receives a tensile force toward the respective both sides along the X direction with the folding region R3 as the center when the chassis members 12A, 12B are open in a use state, and the tensile force applied to the surface member 25 is removed or modified when the chassis members 12A, 12B are closed in a stored state. That is, even though the portion of the bezel member 22 corresponding to the folding region R3 receives a compressing force when the chassis members 12A, 12B are closed, the surface member 25 is only brought back to its original dimension in the X direction at a time with no load applied, with the compressing force. This can reliably prevent the bezel member 22 from wrinkling or sagging due to the compressing force applied in folding. Moreover, as the surface member 25 receives a tensile force toward the outside end faces 12Ab, 12Bb with the folding center O as the center when the chassis members 12A, 12B are open, the surface member 25 does not wrinkle or sag. This further improves the quality of external appearance.

### V. Method for Mounting Bezel Member in the Manufacture of a Portable Information Device

A method for mounting the bezel member 22 such that the surface member 25 receives a tensile force with the portable information device 10 in a use state, as described above, will now be described.

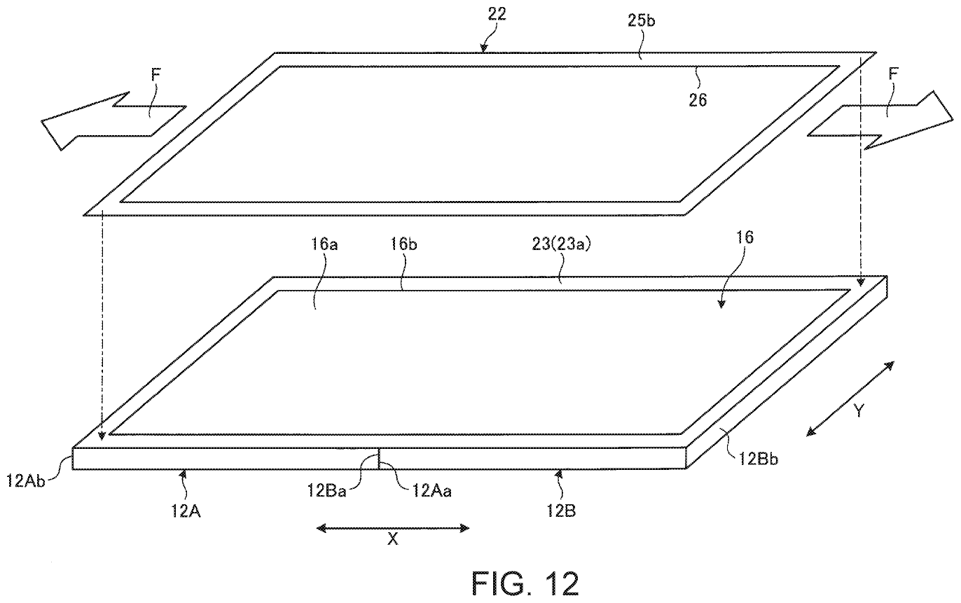

FIG. 12 illustrates a method for manufacturing the portable information device 10.

As illustrated in FIG. 12, initially, the chassis members 12A, 12B with the display 16 thereon are opened flat. Then, as indicated by the arrows F in FIG. 12, the respective both end portions of the bezel member 22 in the X direction are pulled apart from each other to thereby apply a tensile force (tension) F to the bezel member 22, the tensile force F being a force of expanding in the X direction. Then, the bezel member 22 with the tensile force F applied thereto is secured on the chassis members 12A, 12B and the display 16 all being open with the double stick tape 26.

With the above-mentioned method, the bezel member 22 is fixed in a state in which the surface member 25 is receiving the tensile force F in the X direction when the chassis members 12A, 12B are open in a use state, and the bezel member 22 returns to its original state with the tensile force F removed when the chassis members 12A, 12B are closed. Consequently, it is possible to more reliably prevent the bezel member 22 from wrinkling or sagging due to the compressing force applied when the chassis members 12A, 12B are closed.

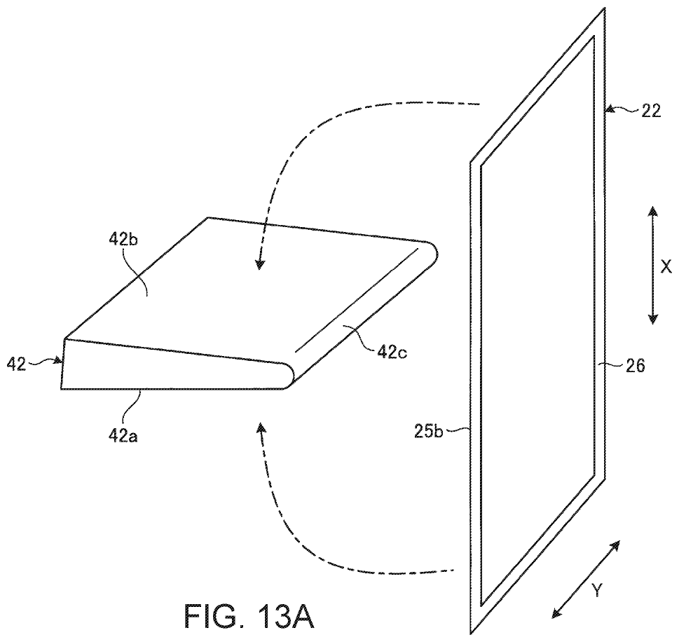

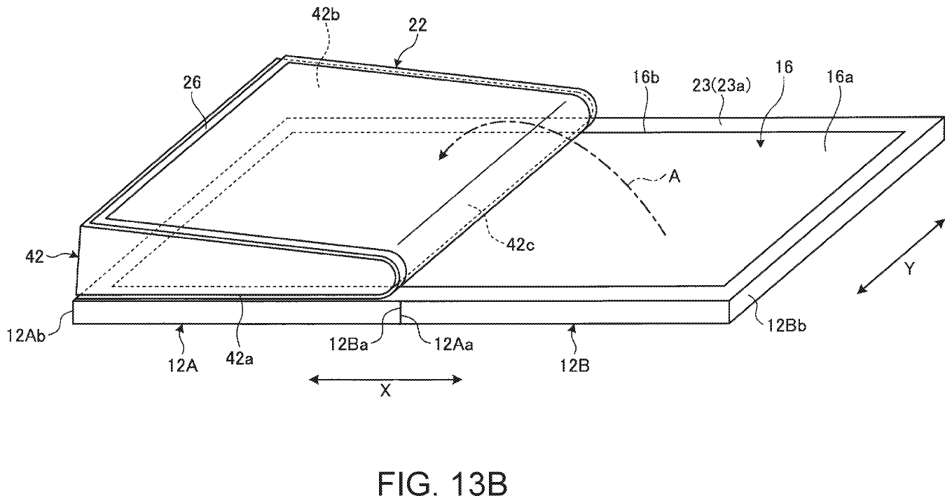

FIG. 13A and FIG. 13B illustrate another method for manufacturing the portable information device 10.

As illustrated in FIG. 13A and FIG. 13B, a jig 42 is used in mounting the bezel member 22. The jig 42 has outside surfaces 42a, 42b, 42c in accordance with the shape of the bezel member 22 with the chassis members 12A, 12B folded as illustrated in FIG. 1. That is, the outside surfaces 42a to 42c have a shape in accordance with the upper surface 25b of the surface member 25 with the portable information device 10 in a use state. Specifically, the outside surface 42a has a shape in accordance with a portion of the bezel member 22 corresponding to the first chassis member 12A and the outside surface 42b has a shape in accordance with a portion of the bezel member 22 corresponding to the second chassis member 12B. Also, the outside surface 42c is a curved surface having a shape in accordance with a portion of the bezel member 22 corresponding to the folding region R3 of the display 16 (refer to FIG. 11C as well).

As illustrated in FIG. 13A, the bezel member 22 is initially set such that its upper surface 25b abuts on the outside surfaces 42a to 42c of the jig 42. Specifically, the upper surface 25b, or a non-adhering surface, of the bezel member 22 is set abutting on the outside surfaces 42a to 42c, whereby the bezel member 22 is folded. In the above, the bezel member 22 may be temporarily secured on the jig 42 with readily removable adhesive agent, for example, not illustrated, provided on the outside surfaces 42a to 42c. Alternatively, a clip, for example, not illustrated, may be used for temporal securing.

Subsequently, as illustrated in FIG. 13B, the chassis members 12A, 12B with the display 16 thereon are opened flat. Then, the portion of the bezel member 22, set on the jig 42, the portion corresponding to the first chassis member 12A is pressed onto the upper surface 23a of the first chassis member 12A and the front surface 16a of the display 16 on the side of the first chassis member 12A. Consequently, the portion of the bezel member 22 corresponding to the first chassis member 12A is secured on the first chassis member 12A and the display 16 with the double stick tape 26.

Subsequently, as indicated by the arrow A drawn with a one-dot chain line in FIG. 13B, the chassis members 12A, 12B are folded via the hinge mechanisms 19. With the above, the portion of the bezel member 22, set on the jig 42, the portion corresponding to the second chassis member 12B is pressed onto the upper surface 23a of the second chassis member 12B and the front surface 16a of the display 16 on the side of the second chassis member 12B.

Consequently, the portion of the bezel member 22 corresponding to the second chassis member 12B is secured on the second chassis member 12B and the display 16 with the double stick tape 26. Thereafter, the jig 42 is removed from the bezel member 22, which completes mounting of the bezel member 22.

As has been described, the present invention provides a foldable portable information device.

Although the portable information device 10 that is foldable in half like a book is described above as an example, the present invention is applicable to a variety of structures, besides a structure in which identically shaped chassis members are folded in half, including, for example, a double-door structure in which a large chassis member has smaller chassis members attached on its respective right and left edges so as to be foldable, an S-shaped folding structure in which a single chassis member has chassis members attached on its respective right and left edges in which the attached chassis members are to be folded in different directions, and a J-shaped folding structure in which a large chassis member has a smaller chassis member attached on its right or left edge so as to be foldable. Four or more chassis members may be connected. In the case where three or more chassis members are connected, the display is provided so as to be foldable between at least two chassis members, the bezel member is provided covering the outer circumferential edge portion of this display, and another display may be mounted on another chassis member.

While the invention has been particularly shown and described with reference to a preferred embodiment, it will be understood by those skilled in the art that various changes in form and detail may be made therein without departing from the spirit and scope of the invention.

What is claimed is:

1. A foldable portable information device, comprising:
a pair of chassis members;
a hinge mechanism rotatably connects said chassis members;
a foldable display straddling inner surfaces of said chassis members; and
a bezel member straddling an outer circumferential edge portion of said display and an outer circumferential edge portion of said chassis members such that said bezel member is disposed farther from a rotation center of said hinge mechanism relative to said inner surfaces of said chassis members, wherein said bezel member includes a core member secured relative to said outer circumferential edge portion of said display and said outer circumferential edge portion of said chassis members, and a surface member made of elastic material and provided on a front surface of said core member.

2. The portable information device of claim 1, wherein said surface member is provided extending over an entire length of said outer circumferential edge portion of said display.

3. The portable information device of claim 2, wherein said core member is provided on said outer circumferential edge portion of said display except a portion of said outer circumferential edge portion, said portion including said respective one edge portions of said pair of chassis members.

4. The portable information device of claim 1, wherein said core member includes a first portion secured on one chassis member and a second portion secured on another chassis member, in which an end face of said first portion and an end face of said second portion are disposed opposed to each other with said portion in-between.

5. The portable information device of claim 4, wherein in said portion, said surface member has a protrusion inserted in a space between said end face of said first portion and said end face of said second portion or a bridge portion extending from a surface of said first portion to a surface of said second portion in order to straddle said space.

6. The portable information device of claim 1, wherein said surface member has a recessed portion formed on a side of a lower surface of said surface member in view of a cross section of said bezel member perpendicular to a longitudinal direction of said bezel member.

7. The portable information device of claim 6, wherein said core member is at least partially held inside said recessed portion.

8. A foldable portable information device, comprising:
a pair of chassis members;
a hinge mechanism rotatably connects said chassis members;
a foldable display straddling inner surfaces of said chassis members; and
a bezel member straddling an outer circumferential edge portion of said display and an outer circumferential edge portion of said chassis members such that said bezel member is disposed farther from a rotation center of said hinge mechanism relative to said inner surfaces of said chassis members, wherein said bezel member receives a tensile force along a direction in which said pair of chassis members are aligned when said pair of chassis members are open flat, and said tensile force is modified when said pair of chassis members are folded.

9. The portable information device of claim 8, wherein said bezel member includes a core member secured relative to said outer circumferential edge portion of said display and said outer circumferential edge portion of said chassis members, and a surface member made of elastic material and provided on a front surface of said core member.

10. The portable information device of claim 9, wherein said surface member is provided extending over an entire length of said outer circumferential edge portion of said display.

11. The portable information device of claim 10, wherein said core member is divided into a portion on a side of one chassis member and a portion on a side of another chassis member by a portion of said outer circumferential edge portion of said display, said portion including said respective one edge portions of said pair of chassis members.

12. A method comprising:
opening a pair of chassis members so that said pair of chassis members become flat;
mounting an elastic bezel member so that said bezel member straddles an outer circumferential edge portion of said pair of chassis members whose respective one edge portions are disposed adjacent to each other and rotatably connected to each other via a hinge mechanism, and an outer circumferential edge portion of a foldable display provided straddling inner surfaces of said pair of chassis members; and
securing said bezel member relative to said pair of chassis members and said display while having said bezel member receiving a tensile force applied thereto along a direction in which said pair of chassis members are aligned.

13. A method comprising:
mounting an elastic bezel member so that said bezel member straddles an outer circumferential edge portion of a pair of chassis members whose respective one edge portions are disposed adjacent to each other and rotatably connected to each other via a hinge mechanism, and an outer circumferential edge portion of a foldable display provided straddling inner surfaces of said pair of chassis members, while using a jig having an outside surface shaped in accordance with a shape of said bezel member with said pair of chassis members in a state of being folded;
setting said bezel member so that said bezel member abuts on said outside surface of said jig;
securing a portion of said bezel member, set on said jig, relative to one chassis member and said display, said portion corresponding to said one chassis member;
subsequently folding said pair of chassis members in order to secure another portion of said bezel member, set on said jig, relative to another chassis member and said display, said other portion corresponding to said other chassis member; and
removing said jig.
